(19) United States
(12) Patent Application Publication
(10) Pub. No.: US 2005/0015267 A1
(43) Pub. Date: Jan. 20, 2005

(54) System and method for incorporation of products and services into reality television

(75) Inventors: Channing K. Barringer, Brooklyn, NY (US); James Hedleston, New York, NY (US); Stefanie Katz-Rothman, New York, NY (US); Cate P. O'Brien, Middletown, NJ (US); Tom Sclafani, New York, NY (US); Nancy Smith, New York, NY (US)

Correspondence Address: SNELL & WILMER;ONE ARIZONA CENTER, 400 EAST VAN BUREN, PHOENIX, AZ, 850040001, US

(73) Assignee: American Express Travel Related Services Company, Inc.

(21) Appl. No.: 10/686,967

(22) Filed: Oct. 16, 2003

Related U.S. Application Data
(60) Provisional application No. 60/488,377, filed on Jul. 18, 2003.
(60) Provisional application No. 60/488,919, filed on Jul. 21, 2003.

(51) Int. Cl. G06F 17/60

(52) U.S. Cl. 705/1

(57) ABSTRACT

The system includes a show and related marketing which discloses details and strategies related to conceiving, opening, operating, improving and growing a business and incorporates a sponsor's products into the storyline and dialog of the show. The information is shared by broadcasting the reality show to build awareness of various aspects of a business and to demonstrate the relevance, importance and problem solving capabilities of certain business products for potential and current participants in similar situations. The invention also allows the participants to provide feedback in the form of suggested strategies for solving business issues disclosed in the storyline of the show. Based on the feedback, the participant may be eligible for a prize and the strategy feedback incorporated into the show.

### CROSS REFERENCE TO RELATED APPLICATIONS

This application claims priority to, and the benefits of, U.S. Provisional Patent Applications entitled “System and Method for Incorporation Financial Products and Services Into Reality Television”, Ser. Nos. 60/488,377 and 60/488,919 filed on Jul. 18, 2003 and Jul. 21, 2003, respectively, the entire contents of which are hereby incorporated by reference.

### FIELD OF INVENTION

The present invention generally relates to marketing of products and services, and more specifically, to systems and methods for incorporating commercial products and services into a reality television program series.

### BACKGROUND OF THE INVENTION

An increasing number of brand advertisers are entering the mass-media marketplace to promote certain products and services, so the advertising channels are becoming crowded with various types of advertisements. The advertisements may include, for example, radio broadcasts, television commercials, infomercials, billboards and internet advertising. Brand marketers have also launched new marketing channels (e.g., mass email) in an attempt to reach more consumers and differentiate themselves. As such, it has become increasingly difficult to capture the attention of consumers and potential consumers, and more specifically, to encourage consumers and potential consumers to remember a specific product. Additionally, consumers have become accustomed to the well-known marketing systems, so consumers have developed ways to avoid or minimize their interaction with marketing activities. For example, consumers often do not open mail from solicitors, sign-up for “do not call” lists, simply hang-up on phone solicitations, filter emails from solicitors, fast-forward through commercials in recorded programs, utilize commercial skipping technology in VCRs and/or engage in other activities during television commercials.

Moreover, with more people entering (or re-entering) the workforce and working longer hours, marketers have faced numerous difficulties trying to reach consumers with highly active lifestyles and limited free time. In other words, these consumers may only be receptive to learning new product information during limited time periods. As such, a need exists for a marketing system which targets consumers during certain activities or during certain time periods. More specifically, a need exists for a marketing system which targets consumers during activities of which the consumer considers enjoyable and which capture the consumer's attention.

One strategy for reaching consumers is the placement of products or commercials in a movie or television program. Recently, “reality” television shows having unscripted storylines wherein the characters are recorded in a natural or “real” setting have enjoyed increasing success and popularity. As a result, marketers often buy commercial time during these programs or place their products on the sets of the programs. However, while brand and product placement in movies and television programs are common marketing strategies, prior art marketing plans have not integrated a marketing campaign into the context of a television program. Moreover, the marketers have not utilized a multiple media approach to advertise within and around television programs. Accordingly, a need exists for more effectively associating products and services with a television program.

### SUMMARY OF THE INVENTION

The invention effectively associates and integrates products and services with a television program by incorporating the products into the storyline and dialog of the show. During certain times in the show, the invention also incorporates commercials which not only include the sponsor's products, but also include educational segments on how the products can help solve the problems encountered by the owner of the business. In one embodiment, the system includes a show and related marketing which discloses details and strategies related to conceiving, opening, operating, improving and growing a business and allows various participants to share this information. The sharing of information may be facilitated by broadcasting the reality show to build awareness of various aspects of a business and to demonstrate the relevance, importance and problem solving capabilities of certain business products for potential and current participants in similar situations. The invention also allows the participants to provide feedback in the form of suggested strategies for solving business issues disclosed in the storyline of the show. Based on the feedback, the participant may be eligible for a prize and the strategy feedback incorporated into the show.

In one embodiment, the entertainment sponsorship marketing system includes: a business operation having an owner, and the business operation featured on a show having a storyline related to the business operation, wherein the business operation comprises independent commerce value distinct from the show. A product is incorporated into the storyline such that a nexus exists between the business operation and the product, and the product is configured to facilitate substantial resolution of certain issues related to the business operation. The storyline is configured to demonstrate the product in context of the business operation.

The system may also include a first marketing channel (e.g., television broadcast) for broadcasting the storyline and a second marketing channel (e.g., commercial or radio broadcast) for demonstrating benefits of the products in the context of said business operation. The system may also include a contest related to the broadcast of the show wherein the contest system receives suggestions from participants for resolution of the issues related to the business operation, selects a winning suggestion, and provides an award to the participant wherein the award may include the participant appearing on the show or the winning suggestion incorporated into the storyline of the show.

### BRIEF DESCRIPTION OF THE DRAWINGS

A more complete understanding of the present invention may be facilitated by referring to the following detailed description considered in connection with the following drawings, in which like numerals represent like elements and in which:

FIG. 1 is a schematic diagram demonstrating exemplary multiple media aspects of the present invention;

FIG. 2 is a schematic diagram of an exemplary participant input process; and,

FIG. 3 is an exemplary screen shot of a webpage which allows participants to submit comments to the owner of the business in the story.

### DETAILED DESCRIPTION

The invention includes a system and method for demonstrating a sponsor's products, resolving issues using the products, and educating participants 15 about a sponsor's 20 products. In one embodiment, the invention includes a show 10 which partially or fully integrates products and services of a sponsor 20 into the storyline and dialog of the show 10, thereby demonstrating the relevancy of the products in context. In this regard, the invention includes an ongoing business operation featured on a television show, wherein the ongoing business operation comprises independent commerce value distinct from the show. In other words, unlike other reality shows wherein the participants would not compete on the island without the existence of the show (e.g., Survivor®), the present invention includes a business operation which existed, and will continue to exist, regardless of the existence of the show. During certain portions of the show 10, commercials are also strategically broadcast which not only include the sponsor's 20 products, but also educational segments on how the products can help solve similar problems encountered by owners of similar or different businesses. In other words, the invention does not merely incorporate a product in the show with special product placement on the set to enhance advertising (e.g., showing a Dell® computer on a desktop); rather, the invention incorporates the product into the operation of the business such that a nexus exists between the business and the product (e.g., using a computer to obtain feedback from other business owners).

The detailed description of exemplary embodiments of the invention herein makes reference to the accompanying figures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

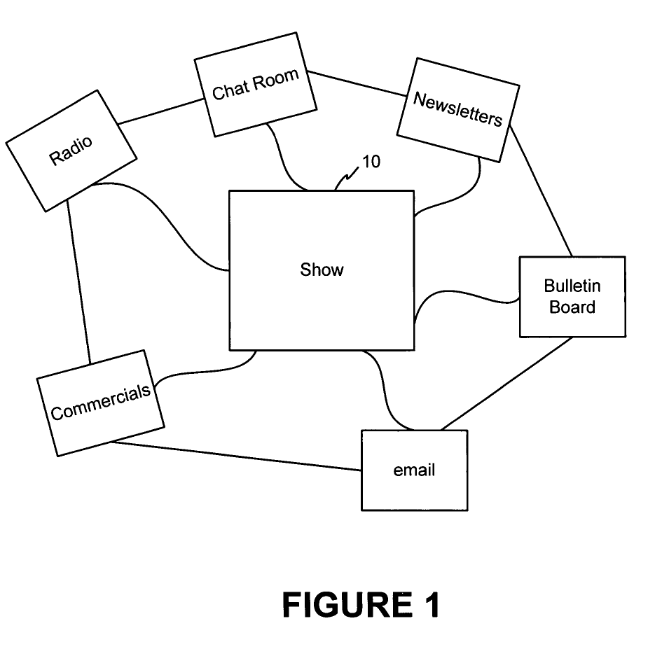

As set forth in FIG. 1, the system and method of the invention may facilitate the providing information to participants through multiple media sources and may allow the show 10 to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

The various system components may be independently, separately or collectively coupled to each other, to the show or to any other network via data links which include, for example, a connection to an Internet Service Provider (ISP) over the local loop as is typically used in connection with standard modem communication, cable modem, Dish networks, ISDN, Digital Subscriber Line (DSL), or various wireless communication methods. See, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

The various system components discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; and/or like data useful in the operation of the present invention. As those skilled in the art will appreciate, any computers discussed herein may include an operating system (e.g., Windows NT, 95/98/2000, OS2, UNIX, Linux, Solaris, MacOS, etc.) as well as various conventional support software and drivers typically associated with computers. The computers may be in a home or business environment with access to a network. In an exemplary embodiment, access is through the Internet through a commercially-available web-browser software package.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, show 10 includes any demonstration, presentation, act, play, movie, DVD, video cassette, CD, audio cassette, monologue, dialog, group discussion, chat room, bulletin board, commercials, infomercials, radio broadcast, internet broadcast, television broadcast, limited access broadcast (e.g., cable, pay-per-view), direct link, print media, publications, emails, newsletters, billboards and/or the like. The show 10 may include any suitable broadcasting components or multi-media features or functions, such as, for example, audio, visual, streaming video, cartoon depiction, animations, feedback forms, integration with other databases or systems, and/or the like. In a particular embodiment, the show 10 includes a reality television show 10, which may include a partially or fully unscripted storyline wherein the characters are recorded in a natural or “real” setting. Any portion of the show 10 may be live or recorded in any medium. The show 10 may include one or more episodes. The episodes may incorporate numerous unrelated, partially related or inter-related issues or each episode may focus on a particular subject, problem, decision, issue and/or product in the areas of business 30, finance, product development, legal, insurance, employment, corporate, tax, health, safety, government and/or the like. As further described below, the show 10 may also include various devices, systems and methods for interacting with the show 10, the sponsor 20, the participants 15 or its products.

As used herein, the products may include, for example, any product, service, person, entity, hardware and/or software. The products may be offered by any person, entity, participant, owner, sponsor 20 of the show 10, or affiliate or partner thereof. The specific products may include, for example, business consulting (e.g., small business consulting), transaction cards, loyalty cards, travel arrangements, retail financial services, merchant services, investments or any other product or service. For example, the sponsors 20 may include a financial services company such as American Express® and its products may include financial services and financial products such as corporate charge cards, travel services and small business network groups. The products may also include a network of similar individuals or businesses which share similar issues and problems, wherein the network facilitates greater and easier communication and interaction between the members of the network (e.g., The American Express OPEN Small Business Network™).

As used herein, a participant 15 includes any person, group, entity, software and/or hardware that is a member of a sponsor 20, views the show 10, participates in the show 10, uses or purchases the products offered on the show 10, a potential customer of the sponsor 20, and/or the like. A participant may also include the owner, employees and/or any other person associated with, or that interacts with, the show.

As used herein, the owner 25 may include any person, group, entity, software and/or hardware that is affiliated with the show 10. In an exemplary embodiment, the owner 25 is an individual that is a small business owner in which the development of his or her business 30 and his or her use of the sponsor's 20 products comprises a portion of the storyline of the show 10. While certain embodiments may refer to actions of or interactions with the “owner”, one skilled in the art will appreciate that references to the actions or interactions of the owner may include the actions or interactions of the owner, employees, participants and/or any other person associated with the show.

With respect to product integration, the invention facilitates the disclosure and sharing of valuable information regarding certain subject matter. In one embodiment, the system discloses details and strategies related to conceiving, opening, operating, improving and growing a business 30 and allows various participants 15 to share this information. The sharing of information may be facilitated by broadcasting the reality show 10 to build awareness of various aspects of a business 30 and to demonstrate the relevance, importance and problem solving capabilities of certain business products for potential and current participants 15 (e.g., other small business owners) in similar situations. In one embodiment, each episode of the show 10 includes at least one example of how a sponsor's 20 products may help solve a problem which arises in the storyline and how the product may similarly assist almost any small business solve a related problem. The sponsor 20 products may be advertised within the storyline or related commercials as the “preferred” products of the owner 25. The products may be incorporated into the show 10 by, for example, a storyline wherein the owner 25 uses a sponsor's 20 website to obtain information on similar businesses 30, chat with other owners 25, post business 30 related items on an electronic bulletin board, and/or obtain a short term loan to overcome a cash shortage. The invention does not require a visual product placement or a non-integrated, auditory product mention or promotion, but the invention may include such features.

Additionally, the invention may include comprehensive advertising around the show 10 designed to promote the sponsor products, inform and educate viewers about the products and educate viewers about how the products can help solve the problems encountered by the owner 25 in the show. The advertisements may appear and be used in various media including: television, radio, news, the Internet, print, and public relations and other branded events. The advertising may feature, at times, the characters from the show 10 and story-lines may be integrated into the advertising. For consistency and interest, the set of the show 10 may also be used in the commercials. The commercials may also be strategically placed at relevant times in the show 10 storyline.

Specifically, the strategically placed advertising may include certain products which are optimized for helping to solve the problems or issues disclosed at certain times in the storyline of the show 10. For example, the storyline may include the owner running low on cash and using a sponsor's quick loan process through the sponsor's website to obtain extra cash. Accordingly, a commercial related to the sponsor's quick loan process may be broadcast after, during or before this portion of the storyline in the show 10. As another example, the storyline may include the owner not being able to find an acceptable price or delivery timeframe for certain goods or the owner debating about a certain business decision (e.g., how many waiters to hire). The storyline then includes the owner entering a networking website (e.g., OPEN Small Business Network) to post questions related to these issues and the owner quickly obtaining valuable information from other business owners. Accordingly, a commercial related to the functionality and advantages of a sponsor's networking website may be broadcast after, during or before this portion of the storyline in the show 10.

The system may also include interviews with the owner, employees or any other person associated with the show. The interviews may be conducted at business seminars or during radio talk shows. The radio information may also include dialog between the owner and participants regarding business operations. The dialog may be in the form of participants calling into the radio talk show or the disclosure of pre-existing interactions between the participants and the owner by, for example, reading from the owner's diary or log book.

As shown in FIG. 1, the invention may include participation or the distribution of additional information, via the internet, email, chat room, bulletin boards, newsletters, webpage entries, telephone, fax, radio call-in or other communications. The invention may also include various aspects of interactive television. The show 10 may also instruct participants 15 to enter a website to learn more about the problems and issues encountered in the storyline. The invention may allow the user to view related business information on one or more related web pages of different websites on the internet and compare its own business with the business 30 on the show 10. The user may also participate in mock business sessions, provide feedback and strategy suggestions, engage in interactive sharing of information between other merchant participants 15, review database information related to the developing business 30 and/or the like.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Intervase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service which receives a request from a browser which includes a URL (http://yahoo.com/stockquotes/ge) and an IP address (123.56.789). The web service retrieves the appropriate web pages and sends the web pages to the IP address.

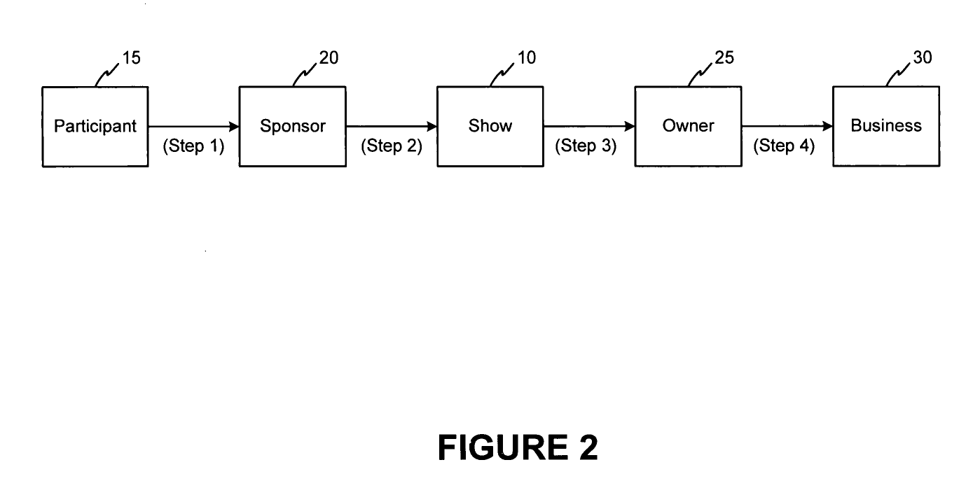

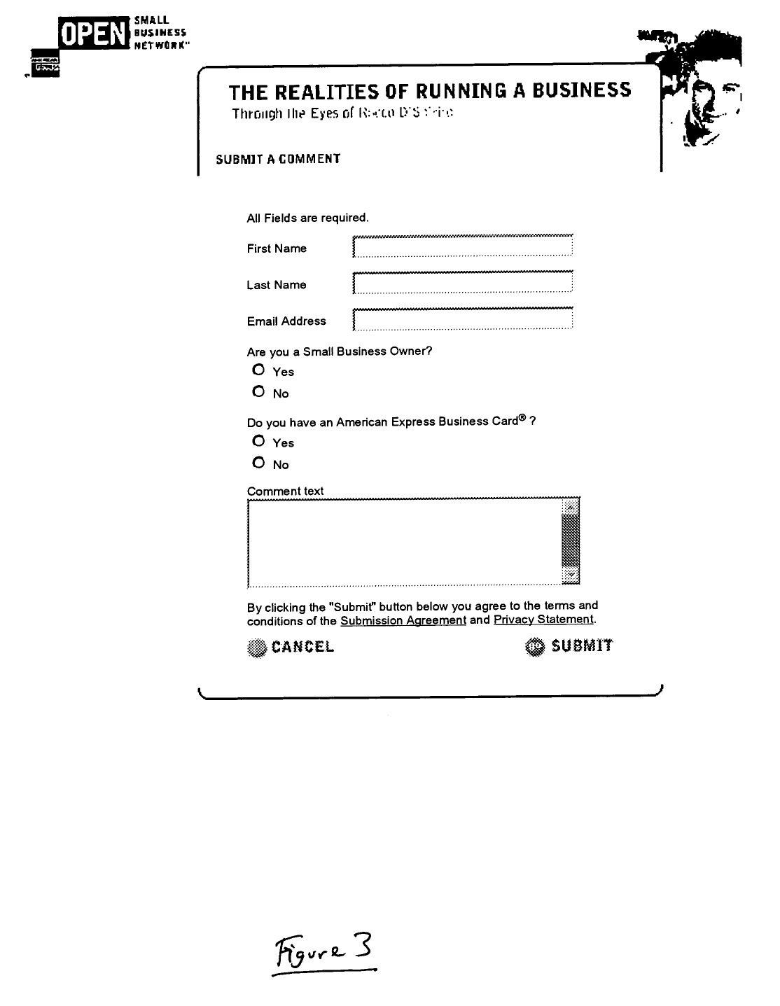

As shown in FIG. 2, the sponsor 20 website may allow participants 15 to post their opinions regarding the owner's 25 decisions during the current or past episodes of the show 10. As shown in FIG. 3, the participant may provide comments or suggestions through the sponsor website (step 1). One skilled in the art will appreciate that any website may obtain participant information and share the information with the sponsor or directly with the show or owner. The sponsor may then aggregate, prioritize, select or re-arrange the input (or use all the input) and store the input in a database. The sponsor may then provide the input to the producer of the show (step 2). The producer may then inform the owner of the suggested input (step 3) such that the owner may use the input to change or improve the business (step 4). In this regard, the changes or improvements may be partially or fully incorporated into the storyline of the show.

The participants 15 may also get involved in an on-line discussion with the owner 25. Furthermore, the participants 15 may view a diary or history log of any portion of the owner's 25 actions and decisions. The diary or history log may be stored in a database on a server associated with a webpage on a website. The participants 15 may then provide comments under each entry or suggest alternative sequences for accomplishing certain tasks. The host of the system may also sponsor 20 events or gatherings for other similarly situated owner's 25 or product users to further promote the products and to facilitate introductions of people in similar situations. As shown in FIG. 3, the participants 15 may also contribute ideas and suggested strategies to the owner. The contributed ideas and strategies may be part of contests which may offer show 10 related prizes (e.g., appearance on the show 10) for the “best small business advice”. The owner 25 may also select the best advice and incorporate the advice into the storyline.

Moreover, the system may include apparatus and methods for monitoring involvement by participants 15 in the system (e.g., number of viewers of the show 10), tracking usage of certain products disclosed in the system (e.g., number of people purchasing a sponsor's products), or tracking usage of certain interaction with the system (e.g., website participation). The results of the monitoring and tracking information may be stored in a database on a server associated with a webpage on a website.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like.

The association step may be accomplished by a database merge function, for example, using a “key field” in pre-selected databases or data sectors. More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The system may limit access to a select group of participants (e.g., customers of the sponsor) by requiring, for example, the participant to enter an account number associated with the sponsor account before allowing the participant to provide input to the system. An “account” or “account number”, as used herein, may include any device, code, number, letter, symbol, digital certificate, smart chip, digital signal, analog signal, biometric or other identifier/indicia suitably configured to allow the consumer to access, interact with or communicate with the system such as, for example, one or more of an authorization/access code, personal identification number (PIN), Internet code, other identification code, and/or the like which may optionally be located on or associated with a rewards card, charge card, credit card, debit card, prepaid card, telephone card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device. A consumer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the consumer. A merchant account number may be, for example, any number or alpha-numeric characters that identifies a particular merchant for purposes of card acceptance, account reconciliation, reporting, or the like.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A entertainment sponsorship marketing system including:
a business operation having an owner, said business operation featured on a show having a storyline related to said business operation, wherein said business operation comprises independent commerce value distinct from said show;
a product incorporated into said storyline such that a nexus exists between said business operation and said product, said product configured to facilitate substantial resolution of certain issues related to said business operation; and
said storyline configured to demonstrate said product in context of said business operation.

2. The marketing system of claim 1, wherein said product includes a network for facilitating communication between owners of similar business operations.

3. The marketing system of claim 1, wherein said product includes financial assistance products.

4. The marketing system of claim 1, wherein said product includes at least one of a transaction card, a financial service and a loan service.

5. The marketing system of claim 1, wherein said show is a reality television show.

6. An integrated marketing system incorporating multiple media channels including:
a first marketing channel which broadcasts a show having a storyline related to a business operation, said show incorporating a product into said storyline such that a nexus exists between said business operation and said product, said business operation having an owner and certain issues related to said business operation and wherein said business operation comprises independent commerce value distinct from said show; and,
a second marketing channel which is configured to demonstrate benefits of said products in the context of said business operation.

7. The integrated marketing system of claim 6, wherein said second marketing channel utilizes comments from said owner to demonstrate benefits of said products in the context of said business operation.

8. The integrated marketing system of claim 6, wherein said second marketing channel facilitates resolution of said issues related to said business operation.

9. The integrated marketing system of claim 6, wherein said second marketing channel facilitates receiving input from third parties regarding suggestions for resolution of said issues related to said business operation.

10. The integrated marketing system of claim 6, wherein said first marketing channel is a television broadcast and said second marketing channel is at least one of a radio, internet, email, bulletin board, chat room and commercial.

11. The integrated marketing system of claim 6, wherein said second marketing channel broadcasts said benefits of said product immediately at least one of before and after said first marketing channel broadcasts said product.

12. A marketing contest method comprising:
broadcasting, using a first marketing channel, a show having a storyline related to a business operation, said show incorporating a product into said storyline such that a nexus exists between said business operation and said product, said business operation having an owner and certain issues related to said business operation and wherein said business operation comprises independent commerce value distinct from said show;
receiving suggestions from a plurality of participants, using a second marketing channel, for resolution of said issues related to said business operation;
selecting at least one of said suggestions as a winning suggestion; and,
providing an award to said participant.

13. The marketing contest of claim 13, wherein said award includes at least one of said participant appearing on said show and said winning suggestion incorporated into said storyline of said show.

14. The marketing contest of claim 13 further comprising transmitting, using said second marketing channel, said suggestions to said show.
